(19) United States
(12) Patent Application Publication
(10) Pub. No.: US 2019/0059606 A1
(43) Pub. Date: Feb. 28, 2019

(54) Multifunctional Airbed

(71) Applicant: Yiwei Huang, Shanghai (CN)

(72) Inventor: Yiwei Huang, Shanghai (CN)

(21) Appl. No.: 16/106,023

(22) Filed: Aug. 21, 2018

(30) Foreign Application Priority Data
Aug. 25, 2017 (CN) 201710744729.3

(51) Int. Cl. A47C 27/10; A47C 31/00; A47C 27/08; A63B 6/00; A63B 21/00; A61H 37/00

(52) U.S. Cl. CPC A47C 27/10; A47C 31/00; A47C 27/081; B63B 7/08; A63B 21/4037; A61H 37/005; A63B 6/00

(57) ABSTRACT

The disclosure discloses a multifunctional airbed, comprising a bed body provided with at least two air bags thereon, the bed body and the air bags are both independent chambers, a plurality of air bags being arranged on the same side of the bed body, and gap being arranged between any two adjacent air bags, both provided for users to lie on. By adjusting the inflation and deflation states (including fully inflated, partially inflated and completely deflated) of the air bags, users can bent or tilt the bed to transform it, so to achieve different functions.

### TECHNICAL FIELD

The disclosure relates to a multifunctional airbed.

### BACKGROUND

With industrial transformation and upgrading in recent years, a large number of white-collar workers have emerged. However, due to higher working intensity, long working hours, prolonged sitting but exercise insufficiency, diseases such as lumbago, backache and rheumatism that are previously only popular among blue-collar workers also have a sharp rise among white-collar workers. Moreover, with the popularity of mobile shopping, mobile video games, etc., the number of young people suffering from lumbago, backache and cervical spondylosis (causing insufficiency of cerebral blood supply, dizziness, headache and other symptoms) due to prolonged sitting, reclining and head-bowing has also increased dramatically, a trend likely overtakes the number of patients in middle-aged and elderly population soon.

On the other hand, with the appreciation and gradual acceptance of western lifestyles, the young and middle-aged groups, not only in developed countries but also in developing countries are increasingly interested in outdoor leisure and entertainment, such as drifting, fishing, camping, picnics, hiking, and water sports, thus leading to a huge increase in the demand for inflatable products related thereto, such as inflatable boats, floating mats, beds, inflatable tents, etc.

Therefore, if there is an amphibious product used both indoor and outdoor, which can not only help to alleviate, treat and correct various health problems caused by poor posture at ordinary times, but also provide some leisure and entertainment functions, it will definitely become a popular product on the market because of meeting the two types of needs at the same time.

In response to the above-mentioned needs to solve the health problems, there have been products on the market that are made of memory foam and other materials and have the function of raising knees and feet, such as the product named LEG WEDGE under the brand “THE ANGLE” and the product named Kind Bed Orthopedic Support Pillow Comfort System under the brand “AVANA” on Amazon. However, these products have the following shortcomings:

1. The products are basically made of homogeneous foam of a single hardness, i.e., the hardness is not adjustable, thus easily causing the following problems: a. due to the users are different in weight and back muscle development (e.g., some people are thinner and lighter in weight), the products may be harder or softer for some users, thereby not only causing discomfort, but also failing to support the waist and back of the underweight users by fitting the physiological curve of their back due to the fact that such hardness requires a heavier weight to form the effect of fitting the natural physiological curve of the back of the human body, while those who are heavier may feel too soft; b. the users may require different hardness to meet different needs, e.g., they require a cushion to be softer and more comfortable during watching TV at leisure, but to be higher in hardness during work to keep their attention focused and energetic.

2. Each product has only a single length of backrest, which is suitable for a small range of individuals and low in versatility. Basically, the users are required to choose the product from 3 to 4 sizes according to their own height, e.g., the products under the brand “THE ANGLE” have only four sizes for users to choose from, and the users are required to choose products of different sizes according to their stature. However, if the users of different stature (such as members of one family) desire to share one product, they need to purchase products of different sizes separately, which is not cost-effective.

3. Since a knee cushion named “LEG WEDGE” is separated from the bed body and cannot be fixed, the user easily slips downward and toward the feet when using products like “THE ANGLE” in a half-lying and half-sitting posture. The principle is as follows: when the user watches TV in a half-lying and half-sitting posture, according to the physical mechanics analysis, a horizontal component slipping towards the knee cushion/feet always exists in the horizontal direction due to the body's own weight/gravity, and the closer the body is to lying flat, the greater such horizontal component is. In this case, the fixation of the human body position can only depend on the friction between a lying plane (such as a bed surface) and the user's clothes, however, such friction is often low especially when the bed sheets and clothes are relatively smooth and dry (such phenomenon is quite common in the heated rooms in winter). Thus, in this case, if the knee cushion named “LEG WEDGE” can be fixed on the bed surface, it can directly prevent the user's waist and back from slipping off. Otherwise, if the knee cushion itself cannot be fixed on the bed surface, the user may slowly disengage from the support of the back cushion due to the slipping off, thus the benefit of the product to the back cannot be realized.

4. Due to the fact that the products raise the knees but fail to raise the feet at the same time, lots of benefits from raising the feet are not available although the lumbago is relieved. What's more, some users still use their feet unconsciously to help prevent their body from slipping forward. As a result, the feet are easily swollen over time. In this case, if the user is sitting on a harder surface, the problem is even more serious, and the heel may even ache over time.

5. Unless the users keep their head unmoved, a pillow provided will roll down due to gravity, which makes the users unconsciously maintain a posture to prevent the pillow from moving or slipping off. As a result, the neck will sour and become stiff over time. In addition, the users are not easy to concentrate, but keep worrying the pillow's slipping-off.

6. The price is high.

In the face of the demand for leisure and entertainment products, most of the inflatable products currently available in the industry are only airbeds and floating mats with a single function. Moreover, these airbeds and floating mats have the following defects:

1. Such products cannot be used both in water and on land. At present, the popular airbeds on the market are basically made of pure flocked fabric and are only suitable for indoor use, while the floating mats are basically made of pure PVC material and are only suitable for outdoor use.

2. When in use, most of the products cannot be bent to form a backrest for users to recline, lean, read and so on, even can, the backrest can only provide one fixed length, for example, the float numbered ASIN: B0748NGWZZ by INTEX and the airbed named Dream Glimmers Airbed-Pink by BESTWAY, both sold on Amazon.

3. Most existing airbed products are either single-layered or double-layered (consists one upper air bag and one down air bag with same shape and area), the problems as follows: the single-layer type cannot keep away from the moisture on the ground, while the double-layer type is poor in ventilation due to the contact between the lower bed body and the ground, and a large amount of moisture generated by long-term sleep of the human body is easy to accumulate near the bed body. As a result, users, especially the aged and children, are more easily to catch rheumatism, arthritis, rheumatic heart disease and other chronic diseases after long-term use of such products. In addition, the bed body in direct contact with the ground are also prone to mildew when used in the wild (such as beach, lakeside) or inside canopy/tent with no floor covered areas), if the bed body is made of the popular flocked fabric, above situation gets worse.

4. Such products cannot raise the knees and feet of users, wherein raising knees can ease waist muscles and obviously alleviate lumbago, while raising feet can greatly increase blood return to the heart and blood supply to the brain, relieve edema of feet, prevent varicose veins of lower limbs, and alleviate discomfort symptoms caused by hemorrhoids.

5. Such products cannot allow users to make any common gymnastic postures such as shoulder stand, lying leg raises, sit-ups and push-ups and to further make those postures more challenging to greatly improve their physical condition.

### SUMMARY OF THE DISCLOSURE

The disclosure provides a multifunctional airbed, which overcomes the difficulties of the prior art, and creates a multifunctional large and medium-sized outdoor water recreational product integrating inflatable bed, recliner float, gymnastic bed and yoga mat etc. It can be widely used by adults and children in various seasons and various occasions, including beach and lakeside, sea, lake, pool, garden, indoor, etc.

The disclosure provides a multifunctional airbed, including:

a bed body, and

at least two air bags are connected to the bed body and used as backrests, pillows and for raising knees and feet;

the bed body and the air bags arranged thereon both are independent chambers and are provided for users to lie on.

Further, a plurality of the air bags are arranged on the same side or different sides of the bed body, wherein the air bags extend from one side of the bed body to the other side, and are arranged along the length direction of the bed body.

Further, the air bags are connected to the bed body in fixed or detachable way.

Further, a drawstring bag or longitudinal partition structure, which is parallel to the length direction of the bed body, is arranged inside the air bags and the bed body respectively.

Further, three or more air bags, at least two of which have the same cross-sectional shape, are provided;

The cross section of the air bag is polygonal, circular, elliptical, semicircular or wavy.

Further, the cross section of the air bag is a right triangle or an isosceles right triangle, and the length of the hypotenuse of the right triangular or isosceles right triangular air bag is 10 to 120 cm.

Further, the cross section of the air bag is an isosceles right triangle, and the length of the hypotenuse of the isosceles-right triangular air bag is 50 cm.

Further, the two adjacent air bags form a backrest through connecting devices.

Further, a cup-holding hole is arranged on the bed body.

Further, outer surfaces of the bed body and the air bag are made of non-woven, woven and knitted cotton, hemp or chemical fabric coated with PVC, nylon or TPU coating materials, or made of flocked fabric material, pure PVC material and TPU material.

By adopting the art, the disclosure has the following advantages:

According to the disclosure, the air bags are directly provided for users to lie on in different postures, and by adjusting the inflation and deflation states (including fully inflated, partially inflated and completely deflated) of the air bags, users can bent or tilt the bed to transform it, so to achieve different functions. Therefore, it is a low-priced multifunctional airbed that integrates leisure, entertainment, fitness, healthcare and physiotherapy functions, and is amphibious product suitable for both outdoor and indoor.

The disclosure will be further described below with reference to the drawings by embodiments.

### BRIEF DESCRIPTION OF THE DRAWINGS

FIG. 1 is a structural diagram of the first embodiment when a multifunctional airbed is in the first state according to the disclosure;

FIG. 2 is a rear view of FIG. 1;

FIG. 3 is a structural diagram of the second embodiment when the multifunctional airbed is in the first state according to the disclosure;

FIG. 4 is a rear view of FIG. 3;

FIG. 5 is a structural diagram when the multifunctional airbed is in the second state according to the disclosure;

FIG. 6 is a rear view of FIG. 5;

FIG. 7 is a structural diagram when the multifunctional airbed is in the third state according to the disclosure;

FIG. 8 is a rear view of FIG. 7;

FIG. 9 is a structural diagram when the multifunctional airbed is in the fourth state according to the disclosure;

FIG. 10 is a structural diagram when the multifunctional airbed is in the fifth state according to the disclosure;

FIG. 11 is a structural diagram when the multifunctional airbed is in the sixth state according to the disclosure;

FIG. 12 is a structural diagram of a first embodiment when a multifunctional airbed is in the seventh state according to the disclosure; and

FIG. 13 is a structural diagram of the second embodiment when the multifunctional airbed is in the seventh state according to the disclosure.

### DETAILED DESCRIPTION OF THE PREFERRED EMBODIMENTS

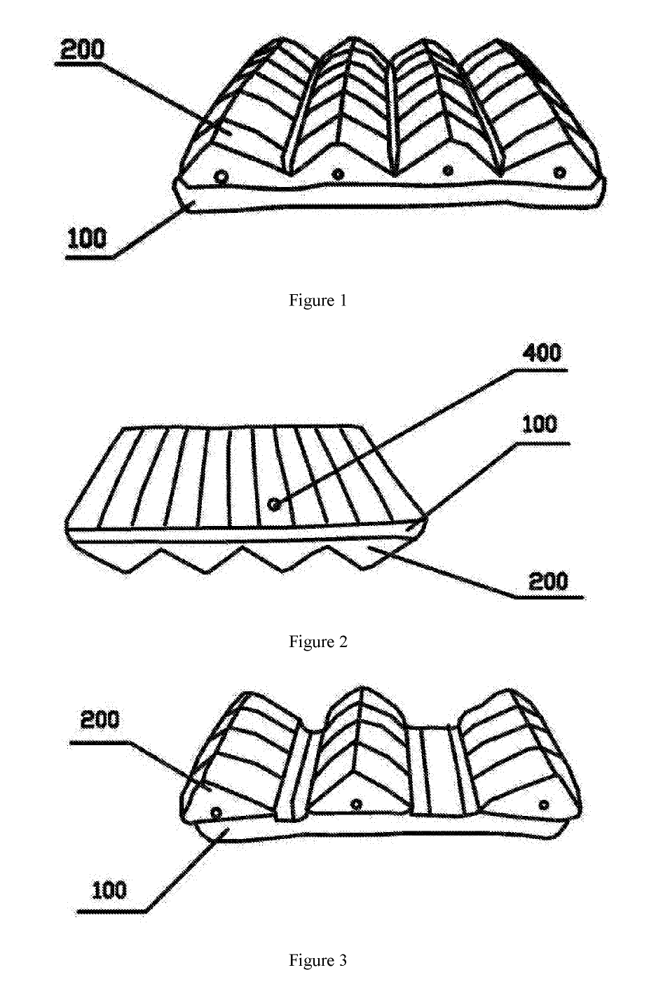

As shown in FIGS. 1 to 13, the multifunctional airbed includes a bed body 100 provided with at least two air bags 200 thereon, wherein the bed body 100 and the air bags 200 are independent chambers respectively, and the air bags 200 are connected to the bed body 100 in fixed or detachable way. The air bags 200 can be fixed to the bed body 100 by welding, gluing and in other manners, and can be detachably connected to the bed body 100 by buckling or the application of the combination of eyelets and rope belts. According to the disclosure, the air bags 200 are directly provided for users to lie on in different postures, and by adjusting the inflation and deflation states (including fully inflated, partially inflated and completely deflated) of the air bags 200, users can bent or tilt the bed to transform it, so to achieve different functions. It will be understood by those skilled in the art that the airbed can be filled with water besides air. Reference will be made only to air inflation to describe the disclosure.

The cross section of the air bag 200 may be polygonal, circular, elliptical, semicircular or wavy, wherein the polygon includes triangle, quadrangle, trapezoid, parallelogram or diamond. Preferably, the cross section of the air bag 200 is in the shape of a right triangle or an isosceles right triangle, and more preferably, the cross section of the air bag is in the shape of an isosceles right triangle for the following reasons: as a dual-purpose product for lying and leaning, it is necessary to ensure that the user can easily change lying and sitting postures. Moreover, an angle of 45 degrees is just the balance point between lying and sitting postures. The user will not feel too hard to change between lying and sitting postures at this angle. User will feel hard to get up at an angle smaller than this angle, while the stress on the waist and back will still be relatively large at an angle larger than this angle, thus failing to play the role of relaxing the waist and back. As the isosceles right triangle has two angles of 45 degrees, it can directly provide the user with two slopes of 45 degrees for lying and reclining when its hypotenuse is welded to the airbed. Moreover, after the isosceles right triangle is rotated 45 degrees, its hypotenuse can also form a slope for lying and reclining, and the static stability is easily acquired on the plane because one right-angle side of the slope is fully supported by the ground. Furthermore, combining two smaller same-dimension isosceles right triangles can form a double-hypotenuse larger isosceles right triangle, so to provide a longer slope for lying and reclining, but still maintain the preferred angle of 45 degrees.

Referring to FIG. 1, the bed body 100 is a cuboid, and four air bags 200 which are arranged on one side of the bed body 100 and extend from one side of the bed body 100 to the other side are provided, i.e., both ends of the air bags 200 respectively correspond to those of the bed body 100, and the four air bags 200 can be arranged along the length direction of the bed body 100, wherein a gap of 10 cm or more is arranged between the two adjacent air bags 200. The product has an obvious advantage of stability by providing four air bags 200, i.e., four tread points, so that the airbed is more suitable for those users who prefer to sleep for a long time (e.g., all night) in a bed with a certain elevated height, good ventilation and far away from moisture, and require the bed to be relatively stable and level, such as the middle-aged and elderly people with a history of lower back pain. Referring to FIG. 3, three air bags 200 are provided on the bed body 100, which all are in the shape of an isosceles right triangle and welded or glued to the bed body 100 by hypotenuse thereof. The distance between the two adjacent air bags 200 may not be equal, but be 20 cm and 40 cm respectively.

It will be understood by those skilled in the art that the air bags 200 may be located on different sides of the bed body 100. The right-angle sides of the isosceles right triangular air bags can also be fixed (welded, glued, buckled and connected by the eyelets and rope belts) to the bed body so as to obtain a (longer) slope of different lengths for lying and reclining, which is easy to use.

In addition, the air bags 200 may be irregularly arranged on the bed body 100. The product is suitable for those users who have general requirements on the stability of the bed, but require the product to be low in cost and portable, and also do not mind or even expect the bed to be slightly bent.

In conclusion, the reduction in the number of air bags can reduce the cost and the weight accordingly, and facilitate handling and carrying. In particular, the connection between the air bag in the middle in FIG. 3 and the bed body can be realized merely by male and female buckles (e.g., male buckles are arranged on the bed body and female buckles are arranged on the four corners of a bottom surface of the air bag in contact with the bed body) or by arranging more than three eyelets on both the bed body and the air bag and then using a rope belt-like object, so that the air bag becomes a detachable air bag. The advantages of the detachable air bag are as follows: it is convenient for those users who do not need such air bag for the time being and detach it from the bed body so as to further reduce the weight and facilitate carrying. In addition, if the male buckles of the release buckles or the eyelets are arranged at regular intervals at the both ends of the bed body in the middle of the two air bags, the air bags can be fixed at different positions of the bed body to be suitable for users of different heights to adjust to an ideal distance for lying and leaning. Finally, as shown in FIGS. 12 and 13, the air bags can also be connected to any one of the air bags 200 with hypotenuse being fixed to the bed in FIG. 3 to form a longer slope for lying and leaning. Additionally, an increased spacing between the air bags is adopted to hold the user's head, torso and part of the buttocks, compared with the design in FIG. 1, the design in FIG. 2 can skip a deflation process to facilitate users, as well as meet needs for people with different heights.

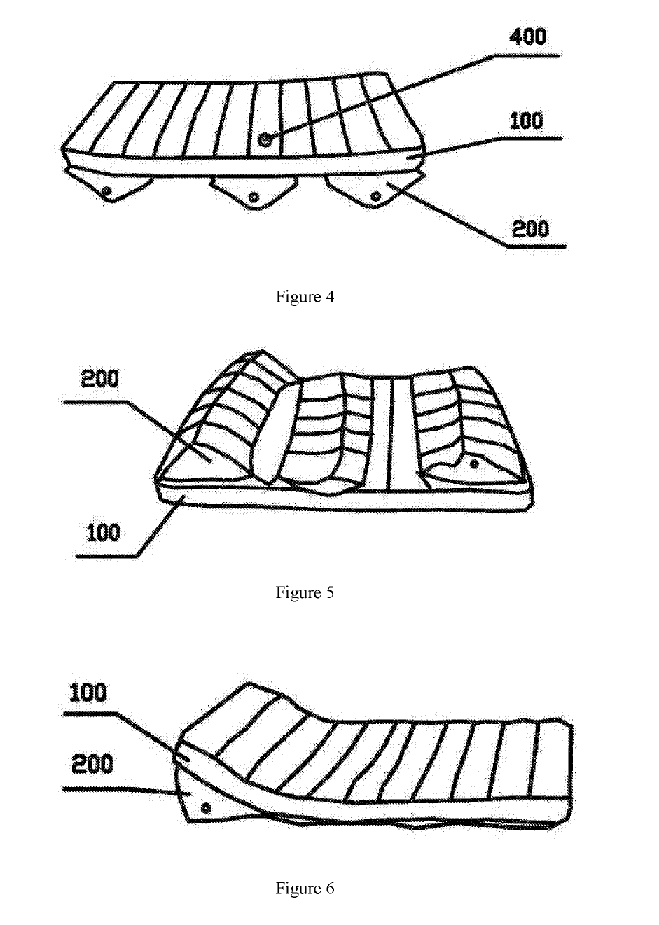

Referring to FIGS. 2 and 4, when a plurality of air bags 200 are used for a fully inflated airbed, the air bags 200 are put downward. In this case, the opposite side of the bed body 100, without air bags 200 arranged/allocated, can be used by users to lie on. The air bags can elevate the bed body so that the bed body is not in direct contact with the ground, the moisture generated by human respiration can be smoothly dissipated from the periphery of the bed body. Moreover, elevated bed body 100 can reduce the negative effect from heavy humidity close to the ground, can prevented users, especially long-term users, from catching diseases such as rheumatism and rheumatic heart, can reduce or prevent mildew on products. Also, dust, insects and small animals are less likely to climb onto the bed to bother users in outdoors (e.g., camping) uses. Furthermore, since a gap is arranged between two adjacent air bags, it can be used for storing things. In addition, the gap can hold the legs of the user. In this case, the side of the bed body without the air bags can be used as a dining table, a game table, a seat, etc. and such design is especially useful if the airbed is used in a limited space, ex. in a tent.

Referring to FIG. 5, the air bag 200 at one end of the bed body 100 is inflated while other air bags 200 are not inflated. One side of the bed body 100 provided with the air bags 200 can be provided for the users to lie on, wherein the inflated air bag 200 can be used as a pillow.

Referring to FIG. 6, the air bag 200 at one end of the bed body 100 is inflated while other air bags 200 are not inflated. The opposite side of the bed body 100 provided with the air bags 200 can be provided for the users to lie on. The end of the bed body 100 provided with the air bags 200 can be bent to form a backrest with gradient. As the backrest is made of air bags, it has elasticity to powerfully support the users of different weights by fitting the curve of their waist and back when lying down, thus solving the problem of single hardness of the foam products. In this case, if the cross section of the inflated air bag 200 is an isosceles right triangle, the gradient of the backrest is 45 degrees.

Referring to FIG. 7, the air bags 200 at both ends of the bed body 100 are fully inflated while the air bags 200 between the two air bags 200 are not inflated. The side of the bed body 100 provided with the air bags 200 can be used for a user to lie on, wherein the user can lie down between the two fully inflated air bags 200. In addition, the two fully inflated air bags 200 can be used as foot cushions or pillows, wherein when the user's feet are raised, the blood return to the heart from the feet and the blood supply to the brain can be increased, the edema of the feet can be alleviated, and the symptoms caused by lower limb varicose veins, hemorrhoids (especially in acute attack period) and the like can be relieved. Based on this, the two fully inflated air bags can be properly deflated to adjust the height of the foot cushions and the height of the pillows. Further, since the air bags are fixed to the bed body, the problems such as slipping off will no longer be worried about or be actually occurred. Moreover, the defects of the other products with single hardness in this posture can also be solved. Referring to FIG. 10, only one airbag 200 located in the middle may not be inflated and other airbags 200 may be fully inflated.

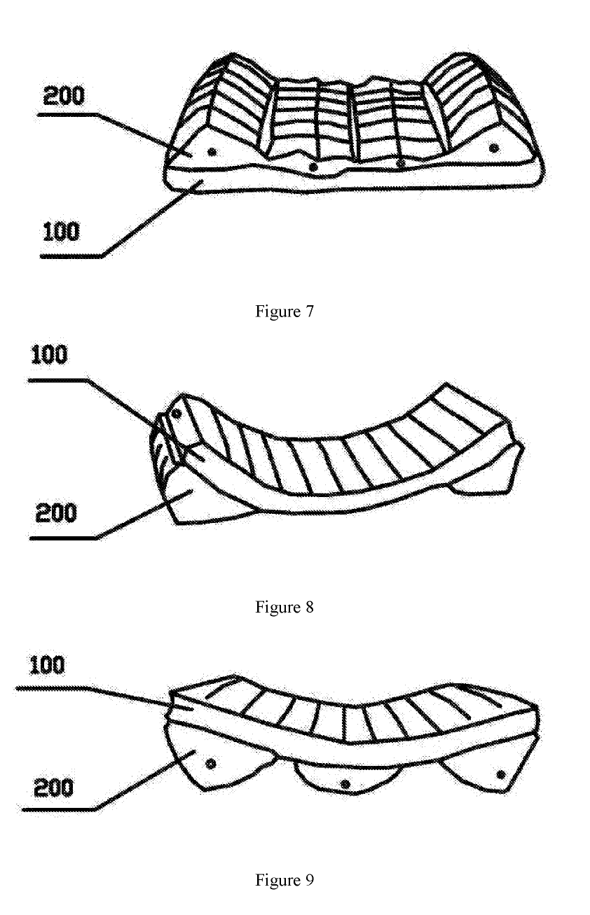

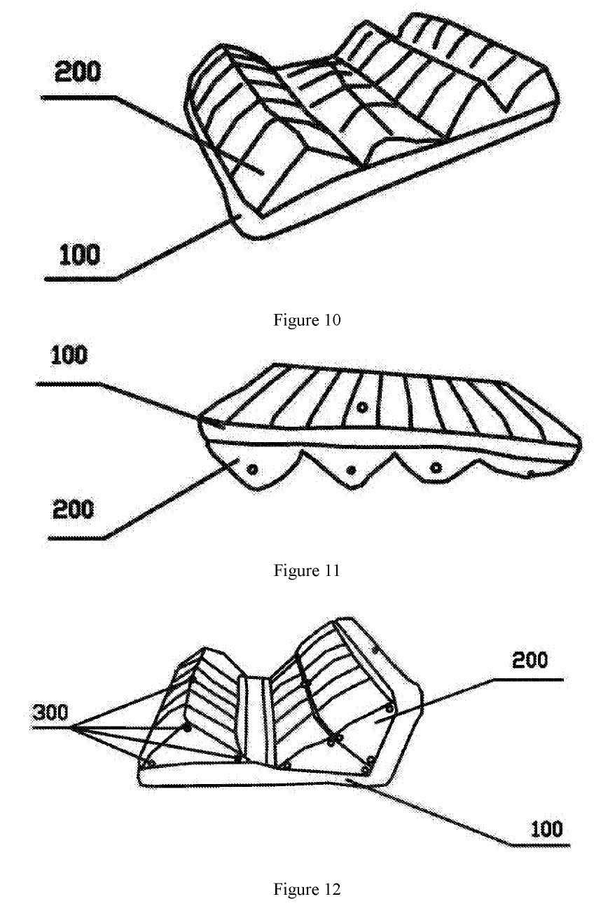

As shown in FIG. 8, the air bags 200 at both ends of the bed body 100 are fully inflated while the air bag 200 between the two air bags 200 is not inflated. The opposite side of the bed body 100 provided with the air bags 200 can be provided for the users to lie on. When the user is lying on the bed body 100, the bed body 100 will form a camber, and the airbed in this state can make the legs of the user tilt up, such hammock-like effect can also be achieved on the water surface. FIG. 9 shows an airbed with its middle air bag 200 being partially inflated, whereby the camber of the bed body 100 can be adjusted according to the saturation degree of the air inside the middle airbag 200.

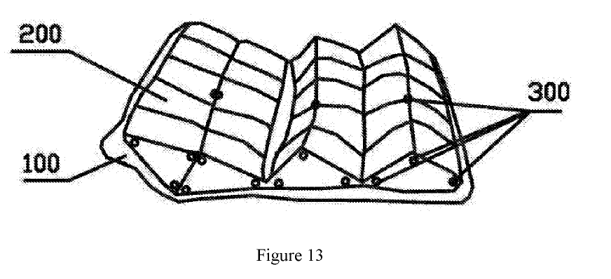

Referring to FIG. 11, the air in the four air bags 200 is inflated decreasingly. Thus, when the opposite side of the bed body 100 provided with the air bags 200 can be provided for the users to lie on, and the inclined bed body 100 can be used for users with insufficient blood supply to the brain after a long period of work, patients in attack period of hemorrhoids or patients suffering varicose veins, can be used for body builders to perform more difficult and challenging movements such as lying leg raises or sit-ups, or can also be used as a slide/slope for children at the poolside and lakeside.

In addition, the saturation level of other air bags 200 can be adjusted to form different products, so that users can perform gymnastic or yoga movements such as sit-ups, push-ups and headstands (against the wall or not) indoors. The air bag 200 at one end of the bed body 100 is not inflated while other air bags 200 are fully inflated, so that the users can sit on the air bag 200 that is not inflated, and can do sit-ups by putting their legs on the air bags 200 that are fully inflated. As the bed can absorb the force applied by the buttocks to the floor when the user sits up, it greatly increases the difficulty of completing the movement, and when the user lies down, a mattress can play a role in protecting the user. When doing push-ups on this product, the users can put their feet on the fully inflated air bags 200 at one end of the bed body 100. Since the exercisers make their feet rest on the air bags which are elastic and transformable, they can only maintain the balance of their body by giving more strength to the arms, shoulders and abdomen due to the unfixed positions of the feet, so that such exercise is undoubtedly more difficult and challenging, and the principle is the same as doing push-ups on an elastic balance ball. In addition, the air bag 200 at one end of the bed body 100 is fully inflated while other air bags 200 are not inflated, the users with their buttocks being put on the air bags that are fully inflated can lie on the air bag that is not inflated, to perform headstands. First of all, compared with ordinary yoga mats and other products, the bed body with a height of 13 cm can provide adequate buffering between the head and shoulders, which are bearing the weight of the whole body (except for the head and shoulders), and the hard floor, thus minimizing injuries to the head and shoulders and doing the movements more comfortably. In addition, when doing headstands movements, in case users (ex. Novices) lose balance and/or going to fall down their legs (ex. Due to long-time post keeping), the bed body can provide an emergent protective buffering area, so to reduce the possibility of injury. For example, users can quickly lean sideways or roll backward once feel they are going to fall down, and try to fall down within the bed range to avoid injury.

Referring to FIG. 12, three air bags 200 are arranged on bed body 100, all of their cross sections are isosceles right triangle, each bag has two cross sections. Each bag has six eyelets located at six corners and each bag has one eyelet located at the center point of the connecting line linking the right angel vertexes of the two cross sections of each air bag 200. Thus seven eyelets 300 are arranged on each air bag 200, and the eyelets 300 on the two adjacent air bags 200 on the bed body 100 can be connected together by ropes, so that the two adjacent air bags 200 can form a backrest with a larger reclining slope length to meet the needs of some tall users. Additionally, using a rope passes through the two eyelets at the two ends of the hypotenuse at the same side of an air bag, connect more eyelets with same locations on one or more air bags, a holding rope can be formed. If the rope passes through both sides of the bed body 100, two holding ropes can be formed as carrying rope. When the airbed is used in water, the two holding ropes can also be temporarily grasped by swimmers for rest.

It will be understood by those skilled in the art that the eyelets 300 can also be replaced by connecting devices such as release buckles, magic buckles or buttons.

Referring to FIG. 13, four air bags 200 are provided, and the two adjacent air bags 200 at one end of the bed body 100 are connected together to form a backrest. It should be noted that the bed body 100 must be partially deflated or not inflated at all so that the two air bags 200 can be connected together. Similarly, if the length of the bed body 100 is long enough and the number of air bags 200 is sufficient, the above structure can be adopted at both ends of the bed body 100. The gradient of the backrest can be adjusted by adjusting the saturation of the two air bags 200 connected together.

The air bags 200 and the bed body 100 are of the type with a drawstring bag or longitudinal partition structure inside. Since inflatable products without a longitudinal partition inside will eventually become a circle after being inflated, causing trouble for users to form an isosceles right triangle as desired, the free flow of air in the air bags can be limited to the greatest extent only by arranging the longitudinal partitions, so that a portion on which the user leans will not collapse significantly but provide a constant stress to conform the natural physiological curve of the back of the human body, giving the user long-term support. Moreover, the magnitude of such support force can be easily adjusted by the air saturation of the triangular air bags.

Outer surfaces of the bed body 100 and the air bags 200 are made of polyester fabric or Oxford fabric material coated with PVC, nylon, TPU or other coatings that also have the function of preventing water leakage and air leakage, instead of traditional flocked fabric or pure PVC material in the inflatable product industry. Such coated fabric has the advantages of high strength, light weight, quick drying, easy cleaning, mildew resistance and being warm in winter and cool in summer, while the products made of the traditional pure PVC material are low in strength, easy to be punctured by sharp objects, and naturally cold to be touched in winter, and the products made of traditional flocked fabric are difficult to get dry after used in water, easy to mildew and fluff. Preferably, if the user desires for an amphibious product, but the surface of the site where the product is used is not very rough (such as soft grass and mud), and few sharp objects such as stone and gravel can be seen in the site; the user does not consider using the product in winter (such as doing body-building exercises indoors), or does not mind that the surface of the product is cold to the touch. In this case, the surface portion of the triangular air bag can only be made of traditional pure PVC material instead of PVC coated fabric to save costs. For those users who do not intend to use the product in water but only on land and prefer warm and fluffy touch, the flocked fabric can also be included within the scope of consideration of the disclosure.

However, it should be noted that it will be understood by those skilled in the art that the PVC coating material contained in the PVC coated polyester or Oxford fabric can also be replaced by nylon, TPU or other coatings that also have the function of preventing water leakage and air leakage, and the polyester or Oxford fabric in the coated fabric can also be replaced by other non-woven fabrics, woven fabrics and knitted fabrics which can also play a similar role as steel bars/reinforced bars in reinforced concrete.

In conclusion, the key to the selection of materials in the disclosure depends on the application/use environments and purposes of the product as well as the user's requirements on cost, weight and lifetime.

In one embodiment, the cross section of the air bag 200 is an isosceles right triangle with a hypotenuse of 10 to 120 cm, preferably with a hypotenuse of 50 cm, for the following reasons:

On the one hand, the hypotenuse cannot be too long:

Firstly, the length of the bed body should generally be no more than 2.1 m, which is basically the maximum length of California type bed. In case of exceeding such length, the cost, weight and the required space to use will all be too large, causing lots of inconveniences to actual use.

Secondly, the preferred total number of air bags is usually at least three or more (because it is a commonsense in geometry that there points define a plane) so to ensure the flatness and stability of the bed. Thus, the maximum allowable length of the air bag 200 is 70 cm.

Thirdly, a certain gap is required to be arranged between the air bags to contain the buttocks and part of the waist of the user. Otherwise, the user cannot lie down but only sit in a leaning posture, and may feel very uncomfortable if the length of the backrest is not long enough. In addition, the users (especially those with large abdomen) may feel very uncomfortable due to the compression from “over-raised” legs.

Finally, it is also the requirement for the disclosure to reserve gaps to achieve the backrest as shown in FIGS. 12 and 13. As the inflatable product will bulge outward after being inflated (especially in case of being inflated completely), it is very difficult to combine two isosceles-right triangular air bags together to form a larger slope if no gap is arranged at all. The gap is preferably at least 20 cm after being tested. For the large-sized air bags (even if the width of a single bed is 85 cm and the length of the hypotenuse of the air bag is 50 cm, the smallest area of thrust surface of the air bag is 85×35 cm), when the number of the drawstring bags or longitudinal partitions is limited (more than 4) due to the restriction of cost and weight, it is quite possible for a single stress surface to bulge out 5 to 10 cm under the condition of complete inflation, so it is more reasonable to reserve a slightly larger gap of 10 to 20 cm for the two air bags.

On the other hand, the hypotenuse cannot be too short:

Otherwise, the height is insufficient, and a ratio of the hypotenuse of isosceles right triangle to the height is 2:1. If the hypotenuse is shorter than 50 cm, the height is less than 25 cm. In this way, the height is still less than that of about 40 to 50 cm of ordinary double-layer airbeds on the market even if the height of 13 cm of the mattress located above is added up. If it can be up over 25 cm, the height of 40 to 50 cm can be basically reached when all air bags are sufficiently inflated.

Also, if the hypotenuse is shorter than 50 cm, a ratio of the hypotenuse of isosceles right triangle to the right-angle sides is \sqrt{2}:1, the side length as well as the length of the reclining slope will be less than 35 cm, which is too short for users who are over 1.7 m tall. According to statistics, the average human body height is just a little less than 170 cm, since the sitting height of people of 170 cm tall is usually half of their height, which is 85 cm, even half of a user's head (usually about 10 cm) is allowed to be higher than the top of the airbag' s isosceles triangular, a space with length of at least 75 cm is still required for lying and reclining. If the length of the backrest is 35 cm which is even less than half of 75 cm, the user will feel very uncomfortable when reclining as if he/she wants to get support from the backrest, his/her reclining posture will be too close to lying-down, thus many things such as reading, watching TV etc. can not be fulfilled.

In conclusion, if the number of air bags is three, the total length has reached 50×3=150 cm, and the three air bags need at least two gaps, the total length of the two gaps is 210 cm−150 cm=60 cm at most. As has been noted, people of 170 cm tall requires space of at least 75 cm long for lying and reclining, while the slope formed by the hypotenuse of 50 cm is only 35 cm long, so that at least one gap is required to be over 40 cm long. In this way, the other gap is at most 20 cm long and just meets the minimum gap requirement, therefore the preferred length of the hypotenuse is 50 cm.

Referring to FIGS. 2 and 4, a cup-holding hole 400 is arranged on the lying and reclining side of the bed body 100 and can be used for holding beverage cans/cups and the like. The cup-holding hole 400 can be made of soft material (such as PVC) so even users touch the hole when lying or reclining, they will not feel uncomfortable.

The above embodiments, which are intended to enable those skilled in the art to understand the content of the disclosure and implement it accordingly, are merely for describing the technical concepts and features of the disclosure, and the scope of patent application of the disclosure cannot be defined only by the embodiments, i.e., any equivalent variations or modifications made in accordance with the spirit disclosed by the disclosure still fall within the scope of claims of the disclosure.

1. A multifunctional airbed, comprising:
a bed body, and
at least two air bags are connected to the bed body and used as backrests, pillows and for raising knees and feet;
wherein the bed body and the air bags arranged thereon both are independent chambers and are provided for users to lie on.

2. The multifunctional airbed of claim 1, wherein a plurality of the air bags are arranged on the same side or different sides of the bed body, wherein the air bags extend from one side of the bed body to the other side, and are arranged along the length direction of the bed body.

3. The multifunctional airbed of claim 1, wherein the air bags are connected to the bed body in fixed or detachable way.

4. The multifunctional airbed of claim 1, wherein a drawstring bag or longitudinal partition structure, which is parallel to the length direction of the bed body, is arranged inside the air bags and the bed body respectively.

5. The multifunctional airbed of claim 1, wherein three or more air bags, at least two of which have the same cross-sectional shape, are provided:
the cross section of the air bag is polygonal, circular, elliptical, semicircular or wavy.

6. The multifunctional airbed of claim 5, wherein the cross section of the air bag is a right triangle or an isosceles right triangle, and the length of the hypotenuse of the right triangular or isosceles right triangular air bag is 10 to 120 cm.

7. The multifunctional airbed of claim 6, wherein the cross section of the air bag is an isosceles right triangle and the length of the hypotenuse of the isosceles right triangular air bag is 50 cm.

8. The multifunctional airbed of claim 1, wherein the two adjacent air bags form a backrest through connecting devices.

9. The multifunctional airbed of claim 1, wherein a cup-holding hole is arranged on the bed body.

10. The multifunctional airbed of claim 1, wherein outer surfaces of the bed body and the air bags are made of non-woven, woven and knitted cotton, hemp or chemical fabric coated with PVC, nylon or TPU coating materials, or made of flocked fabric material, pure PVC material and TPU material.
